(19) United States
(12) Patent Application Publication
(10) Pub. No.: US 2026/0073773 A1
(43) Pub. Date: Mar. 12, 2026

(54) FREE FALL ROULETTE SYSTEMS AND METHODS

(71) Applicant: Interblock d.o.o., MENGES (SI)

(72) Inventors: Urban BERGANT, Kamnik (SI); Andrej TOMELJAK, Preserje pri Radomljah (SI)

(21) Appl. No.: 19/308,569

(22) Filed: Aug. 25, 2025

Related U.S. Application Data
(60) Provisional application No. 63/693,164, filed on Sep. 10, 2024.

(51) Int. Cl. G07F 17/32

(52) U.S. Cl. CPC G07F 17/3288; G07F 17/322; G07F 17/3272

(57) ABSTRACT

The present disclosure relates to systems and methods for electronic table gaming. An ejection mechanism holds a ball and ejects the ball into a circular central area. The circular central area comprises obstacles configured to interact with the ball. The ball enters an upper portion of the circular central area, traverses downward past the plurality of obstacles, and exits a lower opening of the circular central area. A rotatable ring is located concentrically outside of the circular central area and comprises a plurality of pockets. Each pocket is open along a wall annular to the central area and may catch the ball exiting the lower opening of the circular central area. One or more optical sensors determine a position of the ball. A first gaming amount is received. The ball is released from the ejection mechanism. The computing device determines a pocket that caught the ball.

### CROSS REFERENCE TO RELATED APPLICATIONS

This application claims benefit under 35 U.S.C. § 119(e) of Provisional U.S. Patent Application No. 63/693,164 , filed Sep. 10, 2024, the contents of which is incorporated herein by reference in its entirety.

### TECHNICAL FIELD

The present disclosure relates generally to the field of gaming, particularly to interactive electronic table games.

### BACKGROUND INFORMATION

Casinos offer a variety of games to attract players. Such games may include live table games (e.g., roulette, craps, blackjack, etc.), virtual games, physical machines (e.g., slot-like machines and electronic table games), individual player machines, stadium-style group stations, and various gameplay combinations.

Traditional roulette tables require a highly skilled dealer to manage gaming events, and players are typically not allowed to interact with the roulette ball or operate the roulette table. A dealer must supervise and manage bets from one or more players, operate the roulette wheel, determine payouts based on the outcome, and address any disputes or technical issues that arise. Many players may be present at a single roulette table, and additional crowds may develop nearby. A live dealer also comes with the potential for human error and payout mistakes, such as where a losing bet is accidentally paid out or more is paid on a winning bet than should have been paid. Casinos and gaming locations operating roulette tables and live table games must therefore innovate to attract and retain players, maintain profitability, and improve player experience.

### SUMMARY

An embodiment is directed to electronic gaming systems, methods, and computer programs. Embodiments comprise a ball and an ejection mechanism configured to hold the ball prior to initiation of a game and to eject the ball into a central area upon initiation of the game. The circular central area comprises a plurality of obstacles protruding from a wall of the central area that are configured to interact with the ball, wherein the ball is configured to enter an upper portion of the circular central area, traverse downward past the plurality of obstacles, and exit a lower opening of the circular central area. A rotatable ring is located concentrically outside of the circular central area, wherein the rotatable ring comprises a plurality of pockets, and wherein each pocket is open along a wall annular to the central area and configured to catch the ball exiting the lower opening of the circular central area. One or more optical sensors are configured to determine a position of the ball. At least one computing device receives, from a console associated with the computing device, a first gaming amount and causes release, from the ejection mechanism, the ball. The computing device determines, based on information received from the one or more optical sensors, a number associated with the pocket that caught the ball.

These and other features will be more clearly understood from the following detailed description taken in conjunction with the accompanying drawings and claims. This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is an example free fall roulette wheel, in accordance with an embodiment.

FIG. 2 is an example free fall roulette wheel with the inner workings visible, in accordance with an embodiment.

FIG. 3 is a conceptual drawing of a player station comprising a free fall roulette wheel, in accordance with an embodiment.

FIG. 4 is an example free fall roulette wheel just prior to a beginning of a game, in accordance with an embodiment.

FIG. 5 is an example free fall roulette wheel with a game in progress, in accordance with an embodiment.

FIG. 6 is an example free fall roulette wheel at a conclusion of a game, in accordance with an embodiment.

FIG. 7 is an illustration of an exemplary block diagram representing a general-purpose computer system in which aspects of the methods and systems disclosed herein or portions thereof may be incorporated

### DETAILED DESCRIPTION OF THE DRAWINGS

The present disclosure describes particular embodiments and their detailed construction and operation. The embodiments described herein are set forth by way of illustration only and not limitation. Those skilled in the art will recognize, in light of the teachings herein, that there may be a range of equivalents to the exemplary embodiments described herein. Most notably, other embodiments are possible, variations can be made to the embodiments described herein, and there may be equivalents to the components, parts, or steps that make up the described embodiments. For the sake of clarity and conciseness, certain aspects of components or steps of certain embodiments are presented without undue detail where such detail would be apparent to those skilled in the art in light of the teachings herein and/or where such detail would obfuscate an understanding of more pertinent aspects of the embodiments

Disclosed herein are methods, systems, and non-transitory computer-readable storage media that provide a live electronic table game (ETG) for free fall roulette gaming.

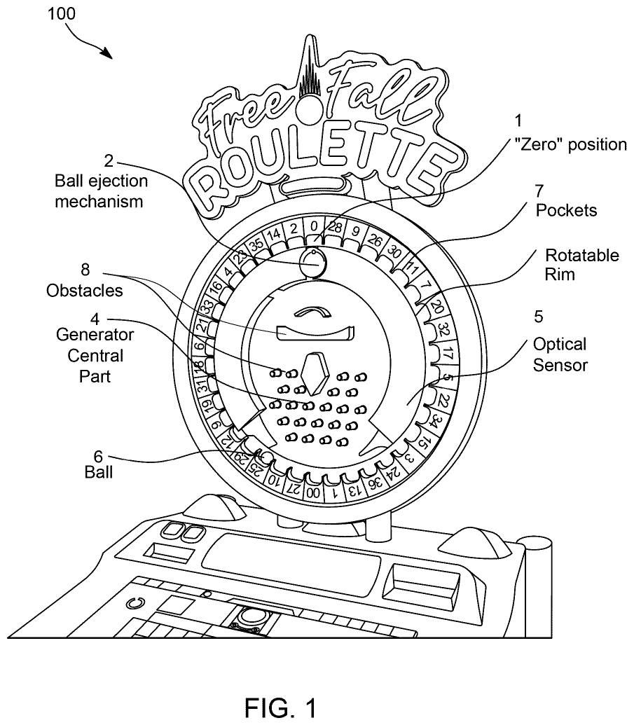

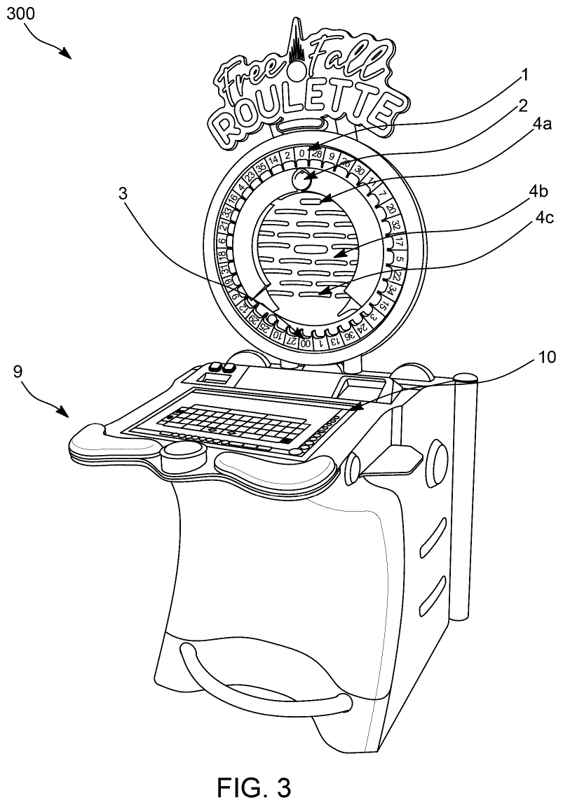

The free fall roulette gaming system comprises a player station to allow one or more players to interact with the free fall roulette gaming system. FIG. 1 and FIG. 3 illustrate a single player station implementation but roulette gaming system could be deployed in a cabinet configuration surrounded by multiple player stations. Thuse, the free fall roulette gaming system may be played by a single player station or a plurality of players. The free fall roulette wheel may be playable by a plurality of players simultaneously, or the free fall roulette wheel may be playable by only a single player simultaneously.

The free fall roulette gaming system may follow the same basic rules of roulette. In traditional roulette, a ball is launched onto a track in the rim of a horizontal roulette wheel rotating in the opposite direction of the ball. When the ball eventually loses sufficient momentum to stay within the track, it falls out of the track and onto a central portion of the wheel comprising a cone surrounded by a circle of pockets, each pocket assigned a number or symbol from a correspondingly labeled circle. The ball will bounce around the central portion and eventually land in a pocket. The number or symbol that corresponds to the pocket will be the winning number/symbol. At the start of each roulette game, players select one or more numbers, symbols or combinations of the same and place gaming amounts to their selections.

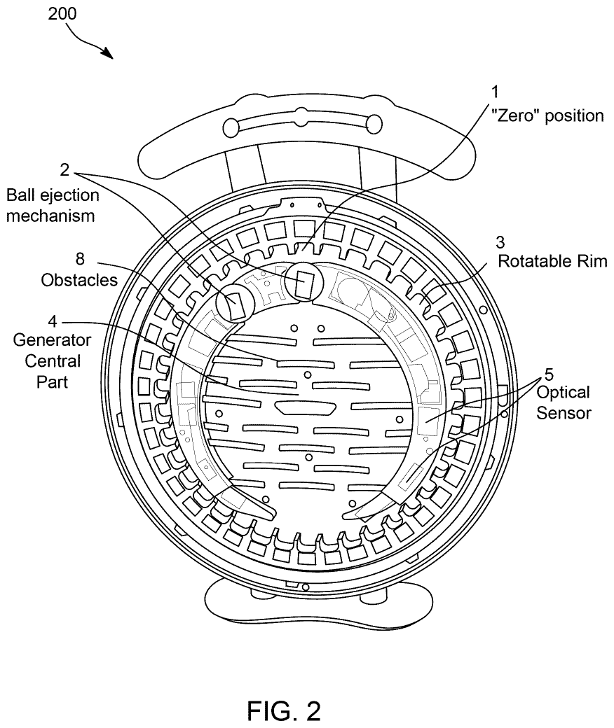

The free fall roulette system uses the same selection and betting rules, but the roulette wheel is different, how the ball is introduced is different and how it gets to a pocket is different. In free fall roulette, the ball may be introduced to a substantially vertical circular central area via a rotatable ring. The circular central area may comprise a plurality of obstacles that affect a path of the ball as the ball falls from the ring into the circular central area and then downward through the obstacles of the circular central area. The obstacles may be similar to a peg board, such as illustrated in FIG. 1 or be a series of platforms as shown in FIG. 2, or have other shapes, and cause the ball to bounce around as it moves downward through the circular central area. The circular central area may be concentrically surrounded by a rotatable ring that resembles a roulette wheel. The rotatable ring may comprise a plurality of pockets associated with individual numbers, colors, or other symbols. For example, the rotatable ring may comprise 38 pockets labeled 0, 00, and 1-36. The rotatable ring may be labeled with colors, for example 18 red pockets, 18 black pockets, and two green pockets. The rotatable ring may be labeled with symbols. The rotatable ring may have any number of pockets and labels. The pockets may be open at a wall annular to the circular central area. The bottom of the circular central area may be open at the annulus between the circular central area and the rotatable ring. The ball may bounce down through the obstacles in the circular central area and pass through the opening into one of the pockets of the rotatable ring. Gaming amounts may be placed prior to initiation of a game, and the gaming amounts may be related to which pocket the ball lands in. The rotatable ring may continue rotating after the ball is caught in a pocket, and the rotatable ring may deposit the ball back in an ejection mechanism at a zero position located near or at the top of the circular central area.

A game cycle may begin with the ball positioned in the ejection mechanism at the zero position. The rotatable ring may be fixed in place at the beginning of the game cycle. The ball may be ejected by the ejection mechanism into the circular central area. The gaming system may comprise one ball or multiple balls. Multiple balls may be ejected into the circular central area and traverse through the obstacles at a same time. The gaming system may comprise one ball that is part of a core game, and one or more additional balls that are introduced to the game under special circumstances. The rotatable ring may begin rotating after the ball is ejected into the circular central area.

The gaming system may comprise a random number generator. The random number generator may generate a range of random numbers, and the generated random numbers may be used to affect a speed of rotation of the rotatable ring. The generated random numbers may accelerate or slow down the speed of the rotatable ring. Upon ejection of the ball into the circular central area, the random number generator may generate a number, and the number may correspond to a particular acceleration or deceleration of the rotatable ring. The rotatable ring may be accelerated or decelerated based on the generated random number. The range of acceleration or deceleration may be related to a time taken by the ball traversing the circular central area. The acceleration or deceleration may correspond up to a ±0.5 rotations of the rotatable ring over an average traversal period of the ball through the circular central area.

The ball may be ejected into the circular central area upon a cue from a player or automatically. The ball may bounce chaotically through the circular central area obstacles and into a pocket of the rotatable ring. The obstacles of the circular central area may be removable, adjustable, or otherwise changed. The obstacles may be changed periodically. The obstacles may be changed to correspond to a theme of the game.

The ball may fall through the circular central area and be caught in a pocket of the rotatable ring. Optical sensors positioned around the rotatable ring may determine which pocket the ball was caught by. The optical sensor or sensors may send a signal to a computing device associated with the gaming system, and the computing device may determine which pocket the ball was caught by. The computing device may present an indication on a player station of the pocket the ball landed in. The gaming system may comprise one optical sensor, two optical sensors, or a plurality of optical sensors on each side of the rotatable ring.

FIG. 1 illustrates an example free fall roulette gaming system. The gaming system 100 comprises a circular rotatable ring resembling a roulette wheel, a circular central area resembling a pegboard or other obstacle course, and a player station for interacting with the gaming system. A zero position 1 represents a position of the rotatable ring 3 of the roulette wheel at rest. The rotatable ring may be in a fixed position in between games, and a pocket labeled “0” may be positioned at the zero position 1 in between games. However, any pocket of the plurality of pockets may be in the zero position 1 in between games. A ball ejection mechanism 2 may be configured to hold a ball 6 prior to initiation of the game. The ball ejection mechanism 2 may eject the ball 6 into a circular central area 4 during gameplay. The rotatable ring 3 may rotate concentrically about the circular central area 4 during game play. The ball 6 may fall through the circular central area and interact with obstacles 8 therein, as indicated in FIG. 1. The ball 6 may fall to a bottom of the circular central area 4 and fall through an opening at the bottom of the circular central area 4. The rotatable ring 3 may have pockets 7 with openings annular to the circular central area 4, and the ball 6 may fall into one of the pockets 7 of the rotatable ring 3. Gaming amounts may be placed on a player station associated with the gaming system, and the gaming amounts may be based on the pocket 7 the ball 6 falls into during each game. The ball 6 may be moved while in a pocket 7 back up to the top of the rotatable ring 3 and the ball 6 may be dropped back into the ejection mechanism 2.

FIG. 2 illustrates another embodiment of the present disclosure. FIG. 2 shows the free fall roulette gaming system 200 from the opposite side of FIG. 1 with the inner mechanisms visible. However, FIG. 2 differs from FIG. 1 in that the pegboard portion of the obstacles 8 have been replaced with a series of platforms over which the ball may bounce and roll and fall in-between neighboring platforms.

FIG. 3 illustrates another embodiment of the free fall roulette gaming system 300 of the present disclosure from the outer side and further illustrating the obstacles of FIG. 2. FIG. 3 also shows an example of a player station 9 comprising a user interface 10 to interact with the gaming station. The free fall roulette gaming system may be played by an individual player as shown in FIG. 3, though the system is not so limited as indicated elsewhere herein and may be used by multiple player stations.

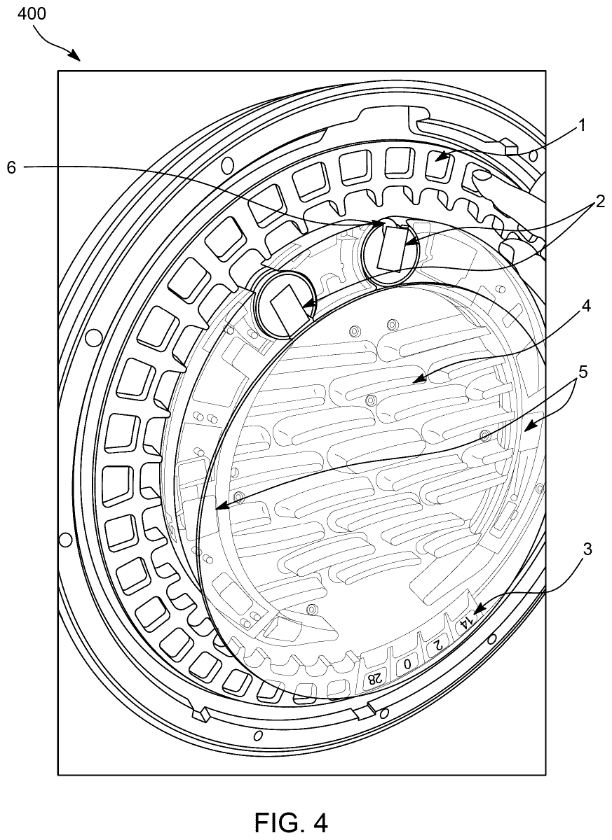

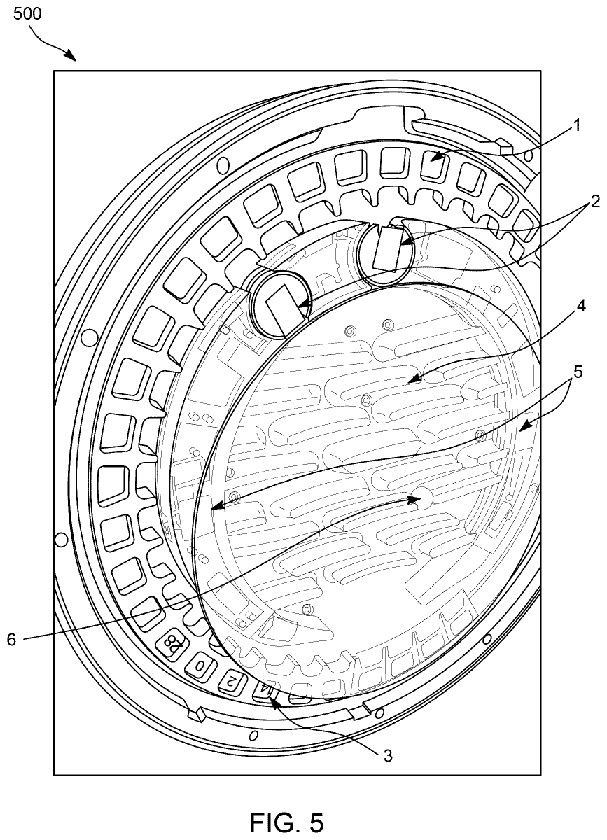

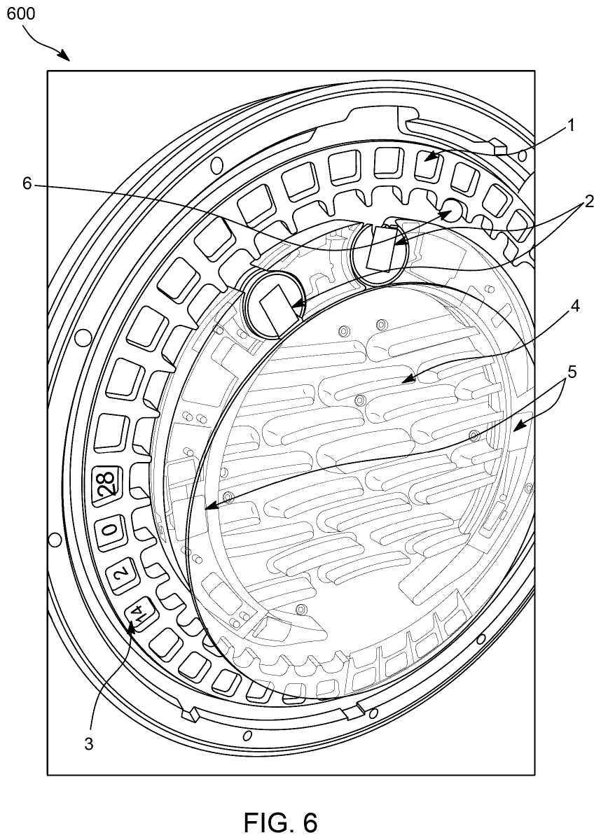

FIG. 4 illustrates another embodiment of the free fall roulette gaming system 400 of the present disclosure prior to initiation of a game. As illustrated, the ball 6 is sitting in a pocket 7 of the rotatable rim 3 and the pocket 7 is aligned with an ejection mechanism 2 prior to being injected into the circular central area 4. FIG. 5 illustrates another embodiment of the free fall roulette gaming system 500 of the present disclosure during operation of a game. As illustrated in FIG. 5, the ball 6 has been injected into the circular central area 4 and may be seen traversing through the obstacles 8 of the circular central area 4 as the rotatable ring 3 may be rotating around the circular central area 4. FIG. 6 illustrates another embodiment of the free fall roulette gaming system 600 of the present disclosure after completion of the game. As illustrated, the ball 6 has landed in a pocket 7 to conclude the game and the rotatable rim 3 is rotating around to bring a pocket 7 back to the zero position 1 so a new game can begin.

The present disclosure describes particular embodiments and their detailed construction and operation. The embodiments described herein are set forth by way of illustration only and not limitation. Those skilled in the art will recognize, in light of the teachings herein, that there may be a range of equivalents to the exemplary embodiments described herein. Most notably, other embodiments are possible, variations can be made to the embodiments described herein, and there may be equivalents to the components, parts, or steps that make up the described embodiments. For the sake of clarity and conciseness, certain aspects of components or steps of certain embodiments are presented without undue detail where such detail would be apparent to those skilled in the art in light of the teachings herein and/or where such detail would obfuscate an understanding of more pertinent aspects of the embodiments.

The techniques described above can be implemented on a computing device associated with a game (e.g., a marble racing game or some other form of amusement game), a plurality of computing devices associated with a plurality of games, a controller in communication with the game(s) (e.g., a controller configured to synchronize the game(s)), or a plurality of controllers in communication with the game(s), such as a GANLOT AMDY-7005, which is designed for gaming applications. The controller module may also provide outputs for the game's lighting, operations, and automated functions.

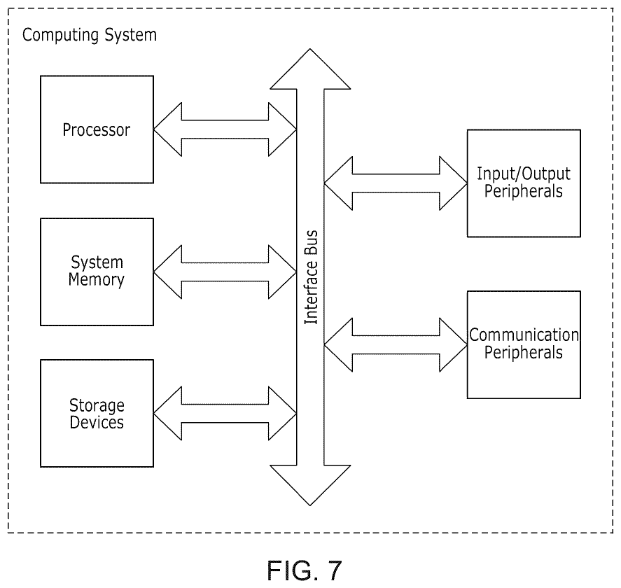

Additionally, the techniques may be distributed between the computing device(s) and the controller(s). FIG. 7 illustrates an exemplary block diagram of a computing system or game server, for games and player stations, that includes hardware modules, software module, and a combination thereof and that can be implemented as the computing device and/or as the server.

In a basic configuration, the computing system may include at least a processor, a system memory, a storage device, input/output peripherals, communication peripherals, and an interface bus. Instructions stored in the memory may be executed by the processor to perform a variety of methods and operations, including the roulette wheel velocity adjustments and result detection optimization, as described above. The computing system components may be present in the gaming device, in a server or other component of a network, or distributed between some combinations of such devices.

The interface bus is configured to communicate, transmit, and transfer data, controls, and commands between the various components of the electronic device. The system memory and the storage device comprise computer readable storage media, such as RAM, ROM, EEPROM, hard-drives, CD-ROMs, optical storage devices, magnetic storage devices, flash memory, and other tangible storage media. Any of such computer readable storage medium can be configured to store instructions or program codes embodying aspects of the disclosure. Additionally, the system memory comprises an operation system and applications. The processor is configured to execute the stored instructions and can comprise, for example, a logical processing unit, a microprocessor, a digital signal processor, and the like.

The system memory and the storage device may also comprise computer readable signal media. A computer readable signal medium may include a propagated data signal with computer readable program code embodied therein. Such a propagated signal may take any of variety of forms including, but not limited to, electro-magnetic, optical, or any combination thereof. A computer readable signal medium may be any computer readable medium that is not a computer readable storage medium and that can communicate, propagate, or transport a program for use in connection with the computing system.

Further, the input and output peripherals include user interfaces such as a keyboard, screen, microphone, speaker, other input/output devices, and computing components such as digital-to-analog and analog-to-digital converters, graphical processing units, serial ports, parallel ports, and universal serial bus. The input/output peripherals may also include a variety of sensors, such as light, proximity, GPS, magnetic field, altitude, and velocity/acceleration. RSSI, and distance sensors, as well as other types of sensors. The input/output peripherals may be connected to the processor through any of the ports coupled to the interface bus.

The user interfaces can be configured to allow a user of the computing system to interact with the computing system. For example, the computing system may include instructions that, when executed, cause the computing system to generate a user interface and carry out other methods and operations that the user can use to provide input to the computing system and to receive an output from the computing system.

This user interface may be in the form of a graphical user interface that is rendered at the screen and that is coupled with audio transmitted on the speaker and microphone and input received at the keyboard. In an embodiment, the user interface can be locally generated at the computing system. In another embodiment, the user interface may be hosted on a remote computing system and rendered at the computing system. For example, the server may generate the user interface and may transmit information related thereto to the computing device that, in turn, renders the user interface to the user. The computing device may, for example, execute a browser or an application that exposes an application program interface (API) at the server to access the user interface hosted on the server.

Finally, the communication peripherals of the computing system are configured to facilitate communication between the computing system and other computing systems (e.g., between the computing device and the server) over a communications network. The communication peripherals include, for example, a network interface controller, modem, various modulators/demodulators and encoders/decoders, wireless and wired interface cards, antenna, and the like.

The communication network includes a network of any type that is suitable for providing communications between the computing device and the server and may comprise a combination of discrete networks which may use different technologies. For example, the communications network includes a cellular network, a Wi-Fi/broadband network, a local area network (LAN), a wide area network (WAN), a telephony network, a fiber-optic network, or combinations thereof. In an example embodiment, the communication network includes the Internet and any networks adapted to communicate with the Internet. The communications network may be also configured as a means for transmitting data between the computing device and the server.

The techniques described above may be embodied in, and fully or partially automated by, code modules executed by one or more computers or computer processors. The code modules may be stored on any type of non-transitory computer-readable medium or computer storage device, such as hard drives, solid state memory, optical disc, and/or the like.

The processes and algorithms may be implemented partially or wholly in application-specific circuitry. The results of the disclosed processes and process steps may be stored, persistently or otherwise, in any type of non-transitory computer storage such as, e.g., volatile, or non-volatile storage.

In an embodiment, a gaming system comprises electronic gaming systems, methods, and computer programs. Embodiments comprise a ball and an ejection mechanism configured to hold the ball prior to initiation of a game and to eject the ball into a central area upon initiation of the game. The circular central area comprises a plurality of obstacles protruding from a wall of the central area that are configured to interact with the ball, wherein the ball is configured to enter an upper portion of the circular central area, traverse downward past the plurality of obstacles, and exit a lower opening of the circular central area. A rotatable ring is located concentrically outside of the circular central area, wherein the rotatable ring comprises a plurality of pockets, and wherein each pocket is open along a wall annular to the central area and configured to catch the ball exiting the lower opening of the circular central area. One or more optical sensors are configured to determine a position of the ball. At least one computing device receives, from a console associated with the computing device, a first gaming amount and causes release, from the ejection mechanism, the ball. The computing device determines, based on information received from the one or more optical sensors, a number associated with the pocket that caught the ball.

In the embodiment, wherein the rotatable ring is fixed in place prior to the initiation of the game and wherein the rotatable ring is rotating during the game.

In the embodiment, wherein the rotatable ring is configured to deposit the ball from the pocket into the ejection mechanism.

In the embodiment, wherein the ball is a first ball and the ejection mechanism is a first ejection mechanism, further comprising a second ejection mechanism and a second ball.

In the embodiment, wherein the second ball is different from the first ball and wherein the first ball solely interacts with the first ejection mechanism and the second ball solely interacts with the second ejection mechanism.

In the embodiment, wherein the second ball is ejected upon an indication of a special game status.

In the embodiment, further comprising a random number generator associated with the computing device, wherein the instructions, when executed further cause at least one of an acceleration of the rotatable ring or a deceleration of the rotatable ring based on an output of the random number generator.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

The present disclosure describes particular embodiments and their detailed construction and operation. The embodiments described herein are set forth by way of illustration only and not limitation. Those skilled in the art will recognize, in light of the teachings herein, that there may be a range of equivalents to the exemplary embodiments described herein. Most notably, other embodiments are possible, variations can be made to the embodiments described herein, and there may be equivalents to the components, parts, or steps that make up the described embodiments. For the sake of clarity and conciseness, certain aspects of components or steps of certain embodiments are presented without undue detail where such detail would be apparent to those skilled in the art in light of the teachings herein and/or where such detail would obfuscate an understanding of more pertinent aspects of the embodiments.

The terms and descriptions used above are set forth by way of illustration only and are not meant as limitations. Those skilled in the art will recognize that those and many other variations, enhancements and modifications of the concepts described herein are possible without departing from the underlying principles of the invention. The scope of the invention should therefore be determined only by the following claims and their equivalents.

What is claimed is:

1. A gaming system, comprising:
a ball;
an ejection mechanism configured to hold the ball prior to initiation of a game and to eject the ball into a circular central area upon initiation of the game;
the circular central area comprising a plurality of obstacles protruding from a wall of the central area and configured to interact with the ball, wherein the ball is configured to enter an upper portion of the circular central area, traverse downward past the plurality of obstacles, and exit a lower opening of the circular central area;
a rotatable ring located concentrically outside of the circular central area, wherein the rotatable ring comprises a plurality of pockets, and wherein each pocket is open along a wall annular to the central area and configured to catch the ball exiting the lower opening of the circular central area;
one or more optical sensors; and
at least one computing device comprising a processor and a memory, the memory comprising instructions, which when executed by the processor, causes the at least one computing device to:
receive, from a console associated with the computing device, a first gaming amount;
cause release, from the ejection mechanism, the ball; and
determine, based on information received from the one or more optical sensors, a number associated with the pocket that caught the ball.

2. The gaming system of claim 1, wherein the rotatable ring is fixed in place prior to the initiation of the game and wherein the rotatable ring is rotating during the game.

3. The gaming system of claim 1, wherein the rotatable ring is configured to deposit the ball from the pocket into the ejection mechanism.

4. The gaming system of claim 1, wherein the ball is a first ball and the ejection mechanism is a first ejection mechanism, further comprising a second ejection mechanism and a second ball.

5. The gaming system of claim 4, wherein the second ball is different from the first ball and wherein the first ball solely interacts with the first ejection mechanism and the second ball solely interacts with the second ejection mechanism.

6. The gaming system of claim 4, wherein the second ball is ejected upon an indication of a special game status.

7. The gaming system of claim 1, further comprising a random number generator associated with the computing device, wherein the instructions, when executed further cause at least one of an acceleration of the rotatable ring or a deceleration of the rotatable ring based on an output of the random number generator.
